(19) United States
(12) Patent Application Publication
(10) Pub. No.: US 2016/0224703 A1
(43) Pub. Date: Aug. 4, 2016

(54) GROWTH STAGE DETERMINATION SYSTEM AND METHOD

(71) Applicant: AgriSight, Inc., Ann Arbor, MI (US)

(72) Inventor: John Shriver, Ann Arbor, MI (US)

(21) Appl. No.: 15/012,749

(22) Filed: Feb. 1, 2016

Related U.S. Application Data
(60) Provisional application No. 62/109,842, filed on Jan. 30, 2015.
(60) Provisional application No. 62/154,936, filed on Apr. 30, 2015.

(51) Int. Cl. G06F 17/50

(52) U.S. Cl. CPC G06F 17/5009

(57) ABSTRACT

A method for in-season crop growth stage determination for crops within a geographic region, the method including: determining a measurement value for a physical geographic region (e.g., a crop field) for a time point based on remote information, determining a transition date based on the measurement value, determining the growth phase for the crops based on the transition date, and determining the crop growth stage based on the growth phase and the environmental parameters for the physical geographic region.

### CROSS-REFERENCE TO RELATED APPLICATIONS

This application claims the benefit of U.S. Provisional Application No. 62/109,842 filed 30 Jan. 2015 and 62/154,936 filed 30 Apr. 2015, which are incorporated in their entireties by this reference.

This application is related to U.S. Provisional Application Nos. 62/109,888 filed 30 Jan. 2015 and 62/130,314 filed 9 Mar. 2015, which are incorporated in their entireties by this reference. This application is related to U.S. application Ser. No. ______ filed 30 Feb. 2016 and titled “System and Method for Field Variance Determination,” which is incorporated in its entirety by this reference.

### TECHNICAL FIELD

This invention relates generally to the agriculture field, and more specifically to a new and useful system and method for in-situ crop growth stage determination in the agriculture field.

### BRIEF DESCRIPTION OF THE FIGURES

FIG. 1 is a schematic representation of the method for in-situ crop growth stage determination.

FIG. 2 is a schematic representation of the method.

FIG. 3 is a schematic representation of a variation of a system and method for in-situ crop growth stage determination.

FIG. 4 is a schematic representation of a variation of determining a growth curve by selecting a representative reference curve from a predetermined set of reference curves.

FIG. 5 is a schematic representation of a variation of determining a growth curve, including determining a second growth curve based on new measurement values.

FIG. 6 is a schematic representation of a variation of determining a growth curve, including determining a second growth curve based on a rolling window of measurement values and calibrating the growth curve selection module based on a measurement value subset and the second growth curve.

FIG. 7 is a schematic representation of a variation of reference curve generation.

FIG. 8 is a schematic representation of a specific example of a variation of the method for in-situ crop growth stage determination.

FIG. 9 is a schematic representation of a specific example of the second variation for determining a growth curve.

FIG. 10 is a schematic representation of a variation of determining whether the transition date has been surpassed based on vegetation index derivatives.

FIG. 11 is a schematic representation of an example of automated action recommendation based on the estimated transition dates for a plurality of fields associated with a user account.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method Overview

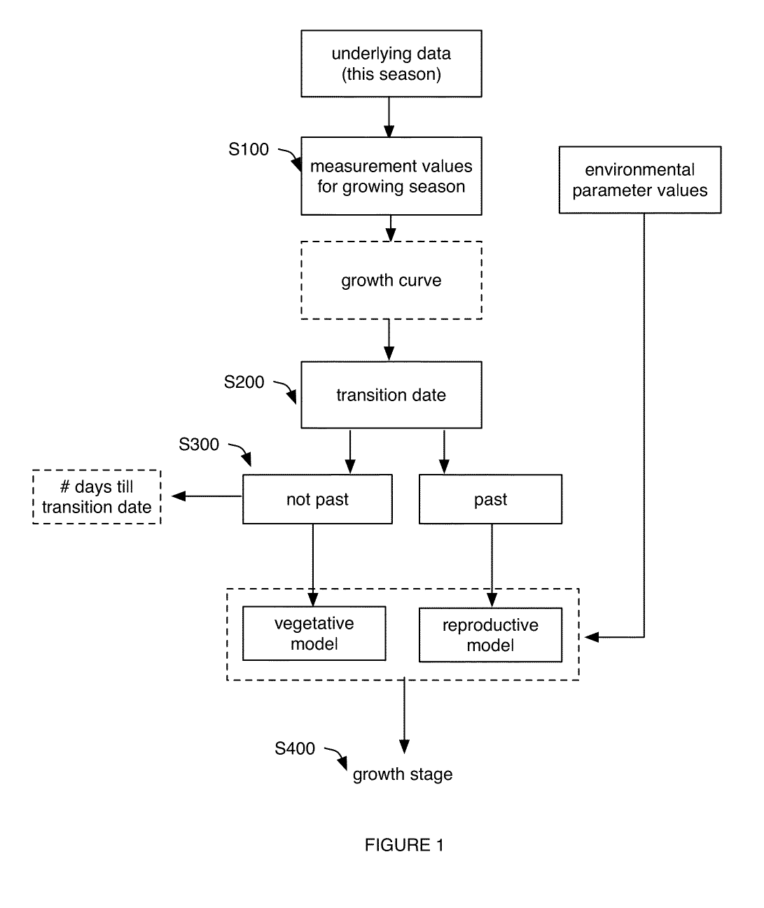

As shown in FIG. 1, the method for in-situ crop growth stage determination includes: determining a measurement value for a physical geographic region (e.g., a crop field) for a time point based on remote information S100, determining a transition date based on the measurement value S200, determining the growth phase for the crops based on the transition date S300, and determining the crop growth stage based on the growth phase and the environmental parameters for the physical geographic region S400. The method functions to predict the growth stage of the crop, which can subsequently enable scheduling and/or performance for growth stage dependent operations, such as crop treatment or harvesting. The method is preferably performed with the system described below, but can alternatively be performed with any other suitable system.

The inventors have discovered that crop growth stages can be more accurately predicted based on remote information by splitting the growth period into a vegetative phase and a reproductive phase, determining whether a threshold proportion of the crop within the field is currently within the vegetative phase or the reproductive phase, and selectively applying a first model (vegetative model) to determine the growth stage of the crop when the crop is determined to be within the vegetative phase or applying a second model (reproductive model) to determine the growth stage of the crop when the crop is determined to be within the reproductive phase. The inventors have additionally discovered that, once the instantaneous growth phase (e.g., vegetative or reproductive) has been determined, the number of aggregate growing degree days for the growing season can be used to more accurately refine the growth stage estimation within each growth phase model.

However, this approach requires a substantially accurate prediction of when reproductive onset occurs (e.g., the transition point between the vegetative phase and the reproductive phase). While the transition point can be retroactively estimated based on a full growing season's worth of data, conventional methods and systems are unable to reliably predict (e.g., forecast) the transition point based on partial growing season data.

The inventors have discovered that the transition point can be estimated substantially accurately (e.g., to within a week, within several days, etc.) based on statistical modeling, using field-specific data from the instantaneous growing season. In particular, the transition point can be estimated by iteratively estimating the shape of the curve for the entire season, based on the past field-specific data for the instantaneous growing season. The transition point can be determined as the inflection point in the curve, the region proximal the curve inflection point, or be defined in any other suitable manner. The inflection point can be the point at which the vegetation index acceleration or velocity (change) is zero, the point at which the vegetation index acceleration transitions from acceleration to deceleration (e.g., positive to negative), the point at which the vegetation index velocity (change) transitions from negative to positive, or be determined in any other suitable manner. The inventors have further discovered that transition point date estimates to within a week can be sufficiently accurate for the purposes of some applications (e.g., planning crop treatment activities, harvesting, crop management, reacting to yield threats, addressing limiting factors such as nitrogen shortages, etc.).

### 2. Benefits

This method can confer several benefits over conventional growth stage estimation methodologies. First, by utilizing remote measurements of the in-situ crops, the method reduces or eliminates the need for a user to scout the field (e.g., record in-field or ground-based measurements).

Second, by utilizing measurements of the crops in-situ (e.g., using up-to-date remotely-sensed imagery of the crops within the field), the method estimates the crop growth stage based on up-to-date parameter values exhibited by the crops themselves. This is in contrast with conventional methods, which estimate the crop growth stage solely based on the factors influencing crop growth (e.g., aggregate growing degree days, relative seed maturity), not based on the up-to-date parameter values exhibited by the crops. By using the parameter values actually exhibited by the crops as the basis for growth stage estimation, this method can more precisely and accurately estimate the growth stage.

Third, because parameter values exhibited by the crops are used as the basis for growth stage estimation, this method latently accommodates for changes in crop growth-influencing factors (e.g., weather, pests, treatments, etc.).

Fourth, some variants of the method can minimize the amount of storage required to continuously monitor a plurality of fields over conventional methods. For example, the method can leverage machine learning models (e.g., random forests) to select the growth curve shape from a plurality of reference curves. This can reduce the amount of required computer storage because only reference curve identifiers and modifiers (e.g., adjustment constants, scaling factors, etc.) need to be stored in association with the geographic region identifier, in contrast with the full reference curve models that need to be stored in conventional methods. Other variants can further reduce the required storage and/or processing load by leveraging a universal growth classification model that determines the growth curve for all geographic regions, in contrast with conventional systems that calculate and store individual growth curve models for each geographic region. The inventors have further discovered that method variants leveraging machine learning models can have comparable or better accuracy and/or precision than methods leveraging shape models.

Fifth, the method can accommodate for the sparse and noisy data extracted from infrequent remote measurements by applying noise reduction processes (e.g., Gaussian smoothing) to the measurements. Some method variants can additionally or alternatively accommodate for outliers in the sparse data by considering a limited, rolling window of past remote measurements for the field (e.g., only consider measurements from the last 10 weeks) when generating the growth curve. Although this can result in incomplete data for the growing season, the inventors have discovered that considering the incomplete data (e.g., only recent measurements) can be preferred, in some variants, over the considering the complete data because recent measurements can have a stronger influence on the transition date estimation than older measurements.

Sixth, the method can accommodate for differences in the remote measurement values due to different crop types collocated on the same field. For example, corn and soy can be grown in the same or adjacent fields, wherein corn can have a different WDRVI value than soy. This WDRVI difference between portions of the field can affect the WDRVI estimate for the field as a whole, which affects the growth curve estimation, transition date estimation, and growth stage estimation.

### 3. System

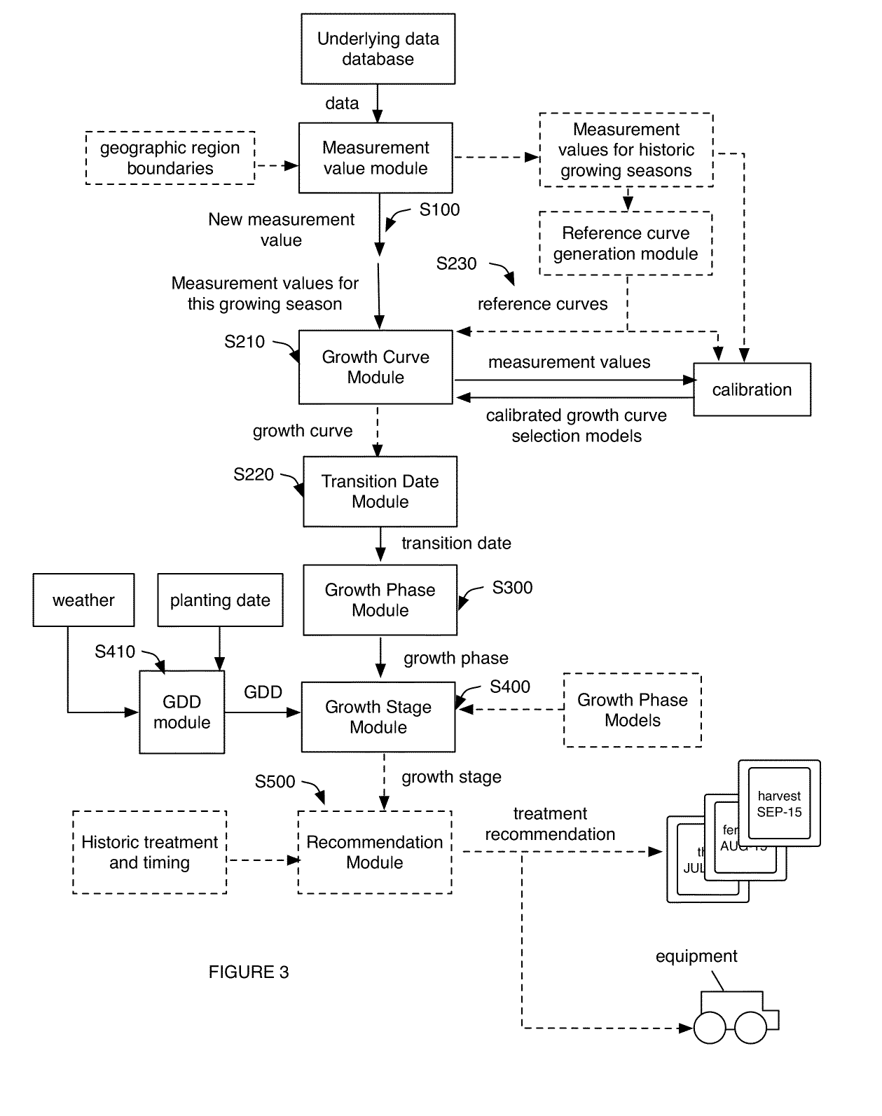

The method can be performed by a plurality of modules, but can alternatively be performed by any other suitable module running a set of computational models. As shown in FIG. 3, the plurality of modules can include: a measurement module, a growth curve module, a calibration module, an aggregate growing degree day module (GDD module), a growth phase module, a growth stage module, and/or any other suitable computation module. The system can additionally include or communicate data to and/or from: an underlying data database (e.g., capturing and/or storing the remote images), user database (e.g., storing user account information, such as associated geographic regions, login information, state, prescriptions, preferences, yield goals, device identifiers, etc.), or any other suitable computing system. Each module of the plurality can be entirely or partially executed, run, hosted, or otherwise performed by: a remote computing system (e.g., a server), a user device (e.g., a native application, web application, or firmware on the user device), or by any other suitable computing system. When one or more modules are performed by the remote computing system, the remote computing system can remotely (e.g., wirelessly) communicate with or otherwise control user device operation. The data used by the modules preferably includes the set of remote measurement values recorded for the geographic region (e.g., measurements of the crops within the field being analyzed), environmental parameter values (e.g., current and past), auxiliary data (e.g., third party data, treatment data, etc.), historic sensor measurement values for past treatments, user inputs (e.g., planting date, field identifiers, etc.), past measurements for the instantaneous growing season (e.g., measurement vales recorded between the planting date and the instantaneous time), or any other suitable set of data.

Each module of the plurality can utilize one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C_{4.5}, chi-squared automatic interaction detection, decision stump, random forest, multivariate adaptive regression splines, gradient boosting machines, etc.), a Bayesian method (e.g., naive Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, boostrapped aggregation, AdaBoost, stacked generalization, gradient boosting machine method, random forest method, etc.), and any suitable form of machine learning algorithm. Each module can additionally or alternatively be a: probabilistic module, heuristic module, deterministic module, or be any other suitable module leveraging any other suitable machine learning method or combination thereof. All or a subset of the modules can be validated, verified, reinforced, calibrated, or otherwise updated based on newly received, up-to-date measurements of the field; past field measurements recorded during the growing season; historic field measurements recorded during past growing seasons, or be updated based on any other suitable data. All or a subset of the modules can be run or updated: once; every year (e.g., after crop harvest, after crop yield is determined, etc.); every time the method is performed; every time an unanticipated measurement value is received (e.g., every time the measured vegetation index value deviates beyond a threshold deviation from the anticipated vegetation index value estimated by the growth curve); or at any other suitable frequency. The modules can be run or updated concurrently, serially, at varying frequencies, or at any other suitable time.

The measurement module functions to determine measurement values indicative of crop performance within the physical geographic region under analysis. The measurement module preferably receives data (e.g., from the data source, external database, internal database, etc.) and extracts the measurement values from the data. The data can be remote data, such as remotely-sensed images (e.g., satellite images or drone-captured images), but can alternatively or additionally determine the measurement values from in-field measurements or from any other suitable data source. The measurement module preferably receives remote data from the remote data source and extracts the measurement values in response to remote data receipt, but can alternatively determine the measurement values in any other suitable manner. The measurement values can be automatically determined from the remote data (e.g., in response to remote data receipt), automatically determined in response to receipt of a user request for the growth stage, received from a user device or user account, or be otherwise determined.

The growth curve module functions to determine a growth curve for the physical geographic region, the crop in-situ within the geographic region, and/or the growing season, and can additionally function to estimate a transition date for the geographic region or perform any other suitable functionality. The system can include one or more growth curve modules. In a first variation, the system includes a different growth curve module for each geographic region. In a second variation, the system includes multiple growth curve modules running in parallel, wherein each growth curve module can determine the growth curve for one or more geographic regions. The geographic regions processed by different growth curve modules can overlap (e.g., multiple growth curve modules can determine the growth curve for one geographic region, concurrently or serially), or be separate and discrete. In this variation, the multiple growth curve modules can be periodically evaluated for accuracy or precision, wherein more accurate growth curve modules can be promoted in use, used as a secondary growth curve determination validation, or be otherwise utilized. In a third variation, the system includes a single, universal growth curve module. In a fourth variation, the system includes a single growth curve module for each major class of growth curves (e.g., a first growth curve module for pest-infested fields, a second growth curve for low-water fields, etc.). However, the system can include any suitable number of growth curve modules associated with the geographic regions in any other suitable manner.

In a first variation, the growth curve module functions as a growth curve selection module, and classifies the set of past measurement values based on a set of predetermined reference curves (model curves) and/or historic measurement value sets (e.g., measurement values recorded over historic growing seasons). In a second variation, the growth curve selection module selects a reference curve from a set of predetermined reference curves that best fits the set of past measurement values. In a third variation, the growth curve module calculates the growth curve that best fits the past measurement values. The growth curve module can additionally pre- or post-process the measurement values for growth curve determination. However, the growth curve module can determine the growth curve for the geographic region based on any other suitable set of data. The growth curve module preferably leverages machine learning methods (e.g., random forest models) to determine the growth curve for the geographic region, but can alternatively leverage shape models, predetermined growth curves (e.g., for the crop type or cultivar), or any other suitable method to determine the growth curve for the geographic region. However, the growth curve module can determine the growth curve shape in any other suitable manner.

The growth curve module preferably determines and stores a different growth curve for each geographic region, but can alternatively or additionally determine and/or store the same growth curve for each geographic region, a different growth curve for each crop type or cultivar, a different growth curve for each user account, a different growth curve for each applied treatment, or any other suitable number of growth curves. A different growth curve for the geographic region is preferably determined for each growing season, but the same growth curve from a past growing season can be used in the current growing season. The growth curve can additionally or alternatively store a set of reference curves.

In one variation, the growth curve module stores a single growth curve for each geographic region, determines an anticipated measurement value for the geographic region, compares the anticipated measurement value with the actual measurement value (e.g., received from the measurement module), and determines the transition date based on the stored growth curve in response to the anticipated measurement value substantially matching (e.g., within a predetermined deviation) the actual measurement value. A calibration module calibrates the growth curve module in response to the anticipated measurement value deviating from the actual measurement value beyond a predetermined deviation, wherein the transition date is determined from the growth curve determined by the calibrated growth curve module. The growth curve module is preferably calibrated based on the past measurement values, but can alternatively be calibrated in any other suitable manner.

In some variations, the system can additionally include a transition date module that functions to determine the transition date. The transition date module preferably receives the growth curve or identifier thereof for the geographic region for the growing season from the growth curve module, and determines the transition date from the growth curve. The transition date module can additionally fit, scale, or otherwise adjust the growth curve to the measurement value set. However, the transition date module can determine the transition date in any other suitable manner. The transition date module preferably provides the transition date to the growth stage module, but can alternatively provide the transition date to any other suitable endpoint.

The aggregate growing degree day module functions to determine the number of aggregate growing degree days (GDDs) for the crops within the geographic region. The aggregate growing degree day module preferably automatically determines the aggregate growing degree days based on past environmental data for the geographic region over the course of the instantaneous growing season (e.g., past temperatures for the field), but can alternatively be determined based on any other suitable set of data. The instantaneous growing season is preferably associated with a planting date, wherein the growing season begins on the planting date, but can additionally or alternatively be associated with any other suitable temporal reference point. The aggregate growing degree day module can calculate the number of aggregate growing degree days at a predetermined frequency (e.g., daily, weekly, etc.), in response to receipt of a new measurement value, or be calculated at any other suitable frequency.

The growth phase module functions to determine the growth phase of the crop within the geographic region for a given time. In particular, the growth phase module determines whether the crops are in a vegetative phase, reproductive phase, or in any other suitable growth phase. The growth phase module preferably receives the transition date from the growth curve module, and determines whether a given date (e.g., the current date) exceeds or precedes the transition date. The growth phase module can determine that the crops are in a vegetative phase in response to the given date preceding the transition date, and determine that the crops are in a reproductive phase in response to the given date exceeding the transition date. However, the growth phase module can determine the instantaneous growth phase of the crops in any other suitable manner.

The growth stage module functions to determine the growth stage of the crops within the determined growth phase. The growth stage module preferably receives the determined growth phase from the growth phase module, determines (e.g., retrieves, selects, calculates, estimates, etc.) a growth phase model based on the determined growth phase; receives the number of aggregate growing degree days from the aggregate growing degree day module; and determines the instantaneous growth stage of the crop based on the determined growth phase model and number of aggregate growing degree days. The growth phase model can be a vegetative model, reproductive model, or any other suitable growth phase model. The growth phase model can be determined based on historic data, received from a third party, or otherwise determined. The growth phase model can be specific to the cultivar, specific to the geographic region, specific to the treatment, specific to the user account, global, or be any other suitable growth phase model. The growth phase model can be updated (e.g., at a predetermined frequency, in response to a discrepancy between the actual and anticipated measurement values, in response to receipt of a user request, etc.) or remain constant.

In some variations, the system can additionally include a reference curve module that functions to generate reference curves. The reference curves can subsequently be used by the growth curve module to determine the growth curve for a geographic region. The reference curve module preferably determines the reference curve based on historic, complete growing season measurement values (e.g., wherein the measurement values span a time period extending from a planting date to a harvesting date for historic growing seasons), but can alternatively be generated based on partial growing season measurement values or generated based on any other suitable data set. The reference curve module can be a shape-fitting module, classification module, regression module, prediction module, or be any other suitable module. Complete measurement value sets for historic growing seasons are preferably used as ground truth data for training the growth curve selection module, but any other suitable ground truth data can be used. Alternatively or additionally, an incomplete measurement value set and a validated growth curve for a growing season can be used to train the growth curve selection module. However, the growth curve selection module can be otherwise generated.

The system and method are preferably used to determine measurement values for a geographic region. The geographic region can be an agricultural field (e.g., crop field), portion of an agricultural field, multiple contiguous agricultural fields, multiple separate agricultural fields, a region encompassing both agricultural fields and developed land, region having similar crop production (e.g., region producing similar yields), or be any other suitable geographic region. The geographic region can be polygonal, circular, or have any other suitable shape. The geographic region is preferably a two- or three-dimensional physical region, but can alternatively be one dimensional or be a point (e.g., a geographic location). The geographic region can be predetermined (e.g., by a political entity or a user), automatically defined (e.g., based on historical vegetation index differences between the geographic region and an adjacent region), manually defined (e.g., received as a geofence from a user), dynamically determined, or otherwise determined. The geographic region can be defined by a geofence, political boundary, management zone, common land unit, geological features (e.g., mountains, rivers, etc.), buildings, or defined in any other suitable manner. The geographic region can be identified by a geographic coordinate system (e.g., geographic latitude and longitude, UTM and/or UPS system, Cartesian coordinates, etc.), an address, a venue name, a common land unit identifier, a management zone identifier, or by any other suitable unique or non-unique identifier. The geographic region preferably encompasses (e.g., includes) a plurality of geographic sub-regions (e.g., contiguous, overlapping, separate and distinct, etc.), but can alternatively encompass a single geographic sub-region.

The system and method are preferably performed based on underlying data, which is processed into measurement values. The underlying data from which the measurement value is determined is preferably remote data of the field (e.g., data gathered by a sensor remote from the field, such as remote images), but can alternatively be proximal data (e.g., data gathered by a sensor proximal the plant or within the field) or be any other suitable type of data. The underlying data is preferably recorded for the field, but can alternatively be recorded at a second geographic region associated with the field. For example, the underlying data is preferably of the field being analyzed, but can alternatively be recorded at a secondary field proximal the field being analyzed. The underlying data preferably includes an image, more preferably a remote image, but can alternatively include a plurality of images, a subset of an image, weather measurements, soil measurements, crop type assignments, or any other suitable set of data. Remote images can include satellite images, drone images, measurements recorded by a terrestrial system (e.g., soil measurements, water measurements, stalk force measurements, etc.), or be any other suitable data about the crops within the field. The data can be the same data (e.g., the same image) used to determine yield proxy maps, monitor crop health, determine nitrogen effects, or be used in any other suitable manner. Alternatively, the data can be different data from that used to determine other field parameters.

The geographic region entirely or partially represented in the piece of data (e.g., in the image) is preferably associated with the piece of data, but any other suitable geographic region can be associated with the piece of data. The data can be associated with the geographic region based on a geographic location associated with the image and the geographic area associated with the sensor's field of view, the recordation time, the location of the data-recording system at the recordation time, geographic region identifiers (e.g., landmarks) appearing within the image, a user input associating the image or portion thereof with a geographic location, or be otherwise associated with the geographic region.

The image can be a two-dimensional image, a one-dimensional image, a three-dimensional image (e.g., generated from two or more images), or have any suitable number of dimensions. The image can be a single image or frame, as captured by the imaging system, or can be a composite image (e.g., mosaic) including multiple images that are stitched together. In variations where the image is a composite image, the individual images constituting the composite image are preferably recorded at substantially the same time point. Alternatively, the individual images are recorded at different time points. However, the images making up the composite image can be recorded at any suitable time point or time points over any suitable time duration or time durations. The image can be a still image, a kinetic image (e.g., a video), or have any other suitable kinetic parameter. The image can be a multispectral image, hyperspectral image, ultraspectral image, be an image captured within the visible range, LIDAR-derived image, ultrasound-derived image, radar-derived measurement, or be an image captured any other suitable electromagnetic or acoustic frequency. Alternatively or additionally, a secondary measurement, such as electric conductivity (e.g., soil conductivity or EC), can be recorded by a secondary sensor and used as an image. In a specific example, soil conductivity measurement values recorded over the geographic region (e.g., with a ground-based soil conductivity meter) can be mapped to a virtual representation of the geographic region, correlated with other images of the geographic region, and used in the method. However, any other suitable signal can be emitted and/or recorded to generate the image. The image can be captured and/or received by an aerial system (e.g., satellite system, drone system, etc.), a terrestrial system (e.g., a camera dragged along the field by a tractor), or any other suitable imaging system.

The image is preferably associated with one or more temporal indicators (e.g., time durations, time units). The temporal indicator can be a time point relative to a time duration, an absolute time (e.g., indicated by a global timestamp), or any other suitable measure of time. The time duration can be a unique or non-unique time duration. Examples of time durations include a unique year (e.g., 2015), a unique growing season (e.g., spring of 2014, fall of 2009, etc.), a growth stage (e.g., vegetative stage, reproductive stage), relative time duration (e.g., spring, growth duration), or any other suitable time duration. The time point relative to the time duration can be a time point within the time duration (e.g., an hour of a day, a day of the week, a day of a month, a day of a year, a week of a year, a month of a year, day of the planting season, growth stage of the growth duration, etc.), or be any other suitable time point. The time points can be unique or repeated (e.g., non-unique, recurrent). Examples of timestamps include a unique global time stamp (e.g., a UTC time stamp), a relative timestamp (e.g., time passed since a reference time), or any other suitable timestamp. Examples of recurrent time units include: a month recurring across multiple years or growing seasons (e.g., January of 2015 and January of 2016, April 5 of Spring 2015 and April 5 of Spring 2016, etc.), a growing degree day recurring across multiple growing seasons, or any other suitable recurrent time unit. In one variation, the vegetation index is determined for each time point having an available set of underlying data (e.g., satellite images), such that multiple vegetative indices are determined for the crop field for different time points over the growing season.

The image is preferably received at a remote computing system that stores and processes the image. Alternatively, the image can be received at a user device, but can additionally or alternatively be received at any suitable component. The image is preferably received from a third-party source (e.g., via a third party service that captured the images), but can be received from a direct source (e.g., directly from an image-taking component, directly from a user device of a grower who captured the image, etc.). However, the image can be received from any suitable entity with any suitable relationship with the component (e.g., remote server) receiving the image. The image is preferably entirely or partially processed by the remote computing system, but can alternatively be entirely or partially processed by a secondary computing system, user device, or any other suitable computing system.

The image preferably includes a set of image elements. Types of image elements can include a pixel, a superpixel, a digital value, an image segment, or any other suitable image element. Alternatively, the image includes a single image element. However, the image can include any number of image elements defined in any suitable fashion. In one example where the image is a composite image, different image elements of the composite image correspond to different time points.

In one variation, the image can be a satellite image encompassing one or more agricultural fields. The image can be associated with a timestamp. The timestamp can be a relative timestamp, such as a time point within a time duration (e.g., 5th measurement of the year, a measurement in Spring, etc.), a global timestamp, such as a unique time (e.g., 2:34 p on May 3, 2012), or be any other suitable timestamp. In one example, the pixel-to-real-world distance (e.g., pixel to real-world meter, pixel to real-world inch, etc.) can be known or estimated based on the satellite height from the field and focal length of the satellite camera. In this example, the image can be divided into a 5 meter by 5 meter grid, where the steps of the method 100 can be performed with respect to the grid.

However, the system and method can be used with any other suitable computing system or set of data.

### 4. Method

### 4.1 Determining a Measurement Value for a Physical Geographic Region.

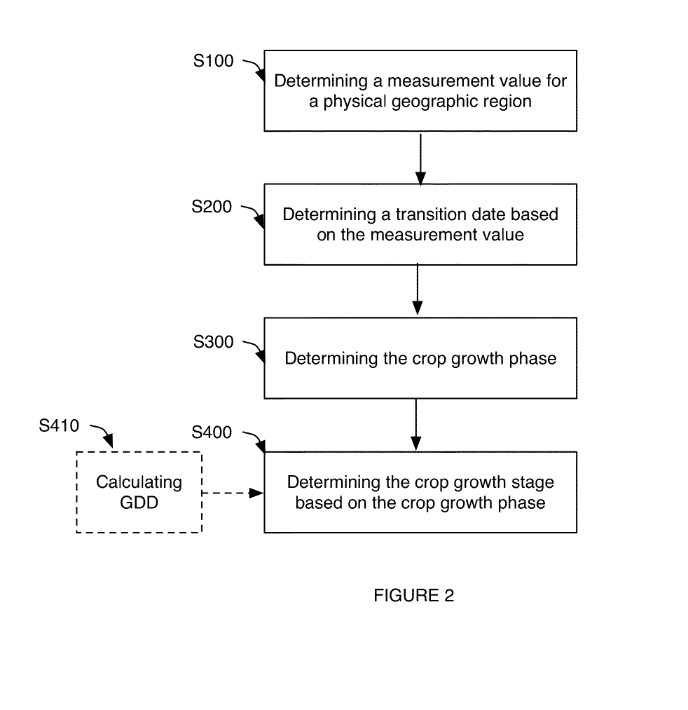

As shown in FIG. 2, determining a measurement value for a physical geographic region S100 functions to determine a measure of the crop performance within the geographic region. The measurement value can be a physiological measurement, morphological measurement, or any other suitable parameter descriptive of one or more plants. Physiological measurements can include vegetation indices, chemical measurements, or any other suitable physiological measurements. The vegetation index is preferably crop-agnostic, but can alternatively be crop-dependent. The vegetation index value can be determined for the entire field, for each of a plurality of field sub-regions, or be determined for any other suitable geographic region. The sub-regions of the field can be substantially similar (e.g., wherein the field is divided into a grid), or be substantially different (e.g., vary in size, shape, etc.). The sub-regions of the field can be automatically determined (e.g., based on historical field performance, variations in past vegetative indices, etc.), manually determined (e.g., received from a user, etc.), or otherwise determined. Vegetation index values can concurrently, sequentially, or otherwise determined for a single crop field or multiple crop fields.

The vegetation index value can include NDVI, such as red NDVI, green NDVI, red edge NDVI, Soil Adjusted Vegetation Index (SAVI), Enhanced Vegetation Index (EVI), Normalized Pigment Chlorophyll Ratio Index (NPCI), Chlorophyll Indices, plant senescence reflectance index (PSRI), Wide Dynamic Range Vegetation Index (WDRVI), or be any other suitable vegetation index or crop physiological measurement. The vegetation index can be used to determine the field's biomass value or any other suitable field parameter, which can subsequently be used to estimate the transition date.

The vegetation index value can be estimated, calculated, or otherwise determined from the underlying data. The vegetation index values can be determined in near-real time (e.g., in response to receipt of the underlying data), batched (e.g., wherein underlying data from a plurality of time points are analyzed together), or be determined at any other suitable frequency.

The vegetation index value is preferably determined for a geographic region, more preferably for each of a plurality of geographic sub-regions, but can alternatively be determined for a plurality of geographic regions or for any other suitable set of geographic locations. In one example, an image is representative of a geographic region, wherein each image element (e.g., pixel) is representative of a geographic sub-region. A vegetation index value is determined for each image segment, based on the respective intensities for each of a set of wavelengths exhibited by the respective image segment (e.g., based on the color exhibited by the image segment). The image segment can be an image element (e.g., a pixel), a plurality of pixels (e.g., contiguous, non-continuous, etc.), or any other suitable set of image elements. The vegetation index value can alternatively or additionally be determined based on the vegetation index values of adjacent image elements, or be otherwise determined.

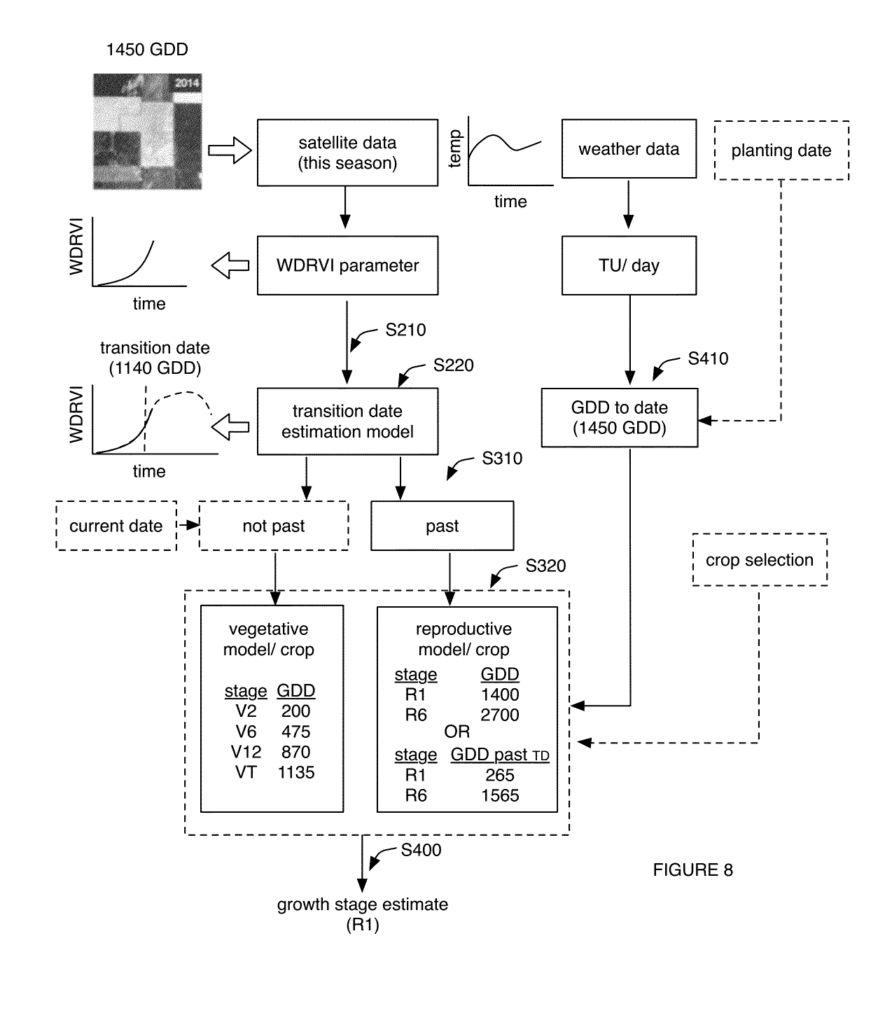

In one specific example, determining the vegetation index measurement includes determining the WDRVI value for a crop field for a first time unit based on satellite images associated with the first time unit (an example of which is shown in FIG. 8). Determining the vegetation index measurement can further include determining a second WDRVI value for the crop field for a second time point after the first time point, based on satellite images associated with the second time point.

In one variation, a single measurement value is determined for the entire field (e.g., geographic region performance value). In one example, the measurement value is determined based on the average signal across the entirety of the image representing the geographic region. In a second variation, a different measurement value is determined for each sub-region of the field (e.g., geographic sub-region performance value, vegetative performance value for an image element), wherein each sub-region can be a pixel of the underlying data (e.g., satellite image), a physical geographic sub-region (e.g., a 5 m by 5 m sub-region), or be any other suitable sub-region. In one example, a vegetation index is calculated for each pixel within the image. In this variation, the geographic region performance value (for the geographic region) can be the average, median, or other aggregate measure based on sub-region vegetation index values. Alternatively, unprocessed geographic sub-region performance values can be used in subsequent processes. However, the geographic region performance value can be otherwise determined.

### 4.1.A Accommodating for Secondary Signals.

Determining the measurement value S100 can additionally include accommodating for secondary signals from within the geographic region, adjacent the geographic region, or otherwise associated with the geographic region. In one example, accommodating for secondary signals can include accommodating for secondary signals concurrently captured within the same image frame as the crops of interest. Secondary signals can result from the presence of secondary plants, such as secondary crops (e.g., soy when the crop of interest is corn), undesired plants (e.g., weeds), or other plants appearing within the same image frame; unplanted regions (e.g., bare soil); or be any other suitable signal.

In a first variation, accommodating for secondary signals can include: segmenting the data by the corresponding geographic sub-region (e.g., dividing the image into a plurality of pixels, each representing a different geographic sub-region); determining the measurement value for each geographic sub-region (e.g., determining the VI for each pixel in the image); determining the signal type for each geographic sub-region (e.g., determining whether the geographic sub-region is associated with the crop of interest or not); masking out the measurement values for geographic sub-regions not associated with the crop of interest; and calculating the measurement value for the geographic region based on the measurement values for geographic sub-regions associated with the crop of interest.

In a second variation, accommodating for secondary signals can include: segmenting the data by the corresponding geographic sub-region; determining the measurement value for each geographic sub-region; determining the plant type growing on each geographic sub-region; and normalizing the measurement values for the geographic sub-regions by crop type (e.g., normalizing measurements for regions growing corn, normalizing measurements for regions growing soy, etc.). This variation can additionally include calculating the measurement value for the geographic region based on the normalized measurement value for a single crop type, calculating the measurement value for the geographic region based on the normalized measurement values for all crop types within the geographic region, or otherwise calculating the measurement value for the geographic region. However, the secondary signals can be accommodated in any other suitable manner.

### 4.2 Determining a Transition Date Based on the Measurement Value.

Determining a transition date based on the measurement value S200 functions to estimate the date at which the crop transitions from the vegetative phase to the reproductive phase. The transition date can be iteratively determined each time new measurement values for the geographic region are determined, be estimated at a predetermined frequency, be determined in response to receipt of a user request, or be determined at any other suitable frequency. A separate transition date is preferably determined for each geographic region (e.g., field, field segment) being analyzed, but a transition date or timeframe for a plurality of geographic regions (e.g., multiple related fields, multiple unrelated fields, etc.) or field sub-regions can alternatively or additionally be determined. In a first example, the method determines a transition date for the geographic region as a whole. In a second example, the method determines a transition date for each geographic sub-region within the geographic sub-region (e.g., a transition date is determined for each geographic sub-region represented by a pixel in an image).

The transition date is preferably a day of the year (e.g., of the instantaneous year), but can alternatively be a number of growing degree days or be any other suitable temporal measure. The transition date is preferably subsequently used to determine whether a vegetative model or a reproductive model should be used to determine the crop growth stage, but can additionally or alternatively be presented to a user (e.g., on a user device, such as a laptop, smartphone, or tablet). The transition date can subsequently be used (e.g., by the user or automatically) to plan future treatments, schedule future operations, forecast harvest parameters (e.g., yield), or used in any other suitable manner. The transition date can be later verified using subsequently collected data (e.g., data collected after the transition date for the field, full growing season data for the field). The transition date determination model can additionally be modified based on the discrepancy between the actual transition date and the estimated transition dates.

The transition date determination is preferably crop-dependent, but can alternatively be crop-agnostic. For example, a first transition date can be estimated for corn while a second transition date can be estimated for soy, based on the same set of vegetation index values. This difference can be due to different models used to estimate the transition dates for different crops (e.g., different curves), or be due to any other suitable estimation differences. The crop type, cultivar, strain, or other crop categorization can be automatically determined (e.g., from the underlying data used to determine the vegetation index value, historical data, etc.), manually determined (e.g., received from the user), or otherwise determined. The transition date can additionally or alternatively be dependent upon local conditions of the field (e.g., environmental parameters, treatments, etc.). For example, the growth curve shape can be flattened or the transition date delayed when the geographic region has suffered from a drought or heat stress during the growing period to date. Alternatively, the growth curve shape can be compressed or the transition date accelerated if growing conditions were favorable during the growing period to date.

### 4.2.A Determining a Transition Date Based on the Measurement Value and a Growth Curve.

In a first variation, determining the transition date based on the measurement value S200 includes determining a growth curve for the crop within the geographic region S210 and determining the transition date based on the growth curve S220.

### 4.2.A.i Determining a Growth Curve.

Determining a growth curve for the crop within the geographic region S210 functions to determine a growth curve shape based on the incomplete crop information from the instantaneous growing season. The growth curve shape is preferably indicative of past and/or future crop development within the geographic region over the growing season, but can be otherwise associated with the geographic region, crops within the geographic region, crop information (e.g., measurement values), or growing season. The growth curve can be iteratively determined each time new measurement values for the geographic region are determined, be determined at a predetermined frequency, be determined in response to receipt of a user request, or be determined at any other suitable frequency.

The growth curve is preferably determined (e.g., calculated, selected, matched, identified, etc.) based on a measurement value set. The measurement value set (vegetation index value set, vegetative performance value set, geographic region performance value set) can include all past measurement values for the growing season (e.g., measurement values for the crop for the geographic region); include a subset of the past measurement values for the growing season; include measurement values from historic growing seasons (e.g., measurement values recorded during growing seasons prior to the current growing season); include forecasted measurement values; or include measurement values from any other suitable growing season. The subset of relevant, past measurement values can be limited to a rolling window of past measurement values for the geographic region, extending a predetermined duration from a reference time (e.g., only measurements from the last 10 weeks are used); past measurement values separated by predetermined intervals; randomly selected past measurement values; or be any other suitable subset of the past measurement values for the growing season. The predetermined duration can be selected by a user, iteratively determined (e.g., based on transition date estimation accuracy), optimized, or otherwise determined. The reference time can be the instantaneous time (current time), the timestamp associated with the most recent image of the geographic region, the timestamp associated with the image of the geographic region under analysis, or be any other suitable reference time. The measurement values are preferably for the physical geographic region under analysis, but can alternatively or additionally be determined based on measurement values for other geographic regions sharing characteristics with the geographic region under analysis (e.g., physical proximity, similar planting date, similar weather conditions, similar cultivar, etc.), or based on measurements for any other suitable geographic region. The measurement value set can be updated (e.g., resampled) each time a new measurement value is received for the geographic region, resampled each time a growth curve is determined for the geographic region, resampled at a predetermined frequency, or determined at any other suitable frequency.

A different growth curve is preferably determined and stored for each geographic region. Alternatively, the same growth curve can be determined and stored for all geographic regions (e.g., be a universal or global growth curve), a subset of the geographic regions, one or more geographic sub-regions, or any other suitable geographic region. The determined growth curve is preferably specific to each growing season, but can alternatively be the same across one or more growing seasons. A new growth curve can be determined each time new data is received for the geographic region and/or crops. Alternatively, the previously determined growth curve can be adjusted based on the new data. Alternatively, the previously determined growth curve can be validated based on the new data, wherein a new growth curve can be determined when there is a discrepancy between the new data and the previously determined growth curve. However, the growth curve can be determined at any suitable time.

### 4.2.A.i. a Selecting a Growth Curve.

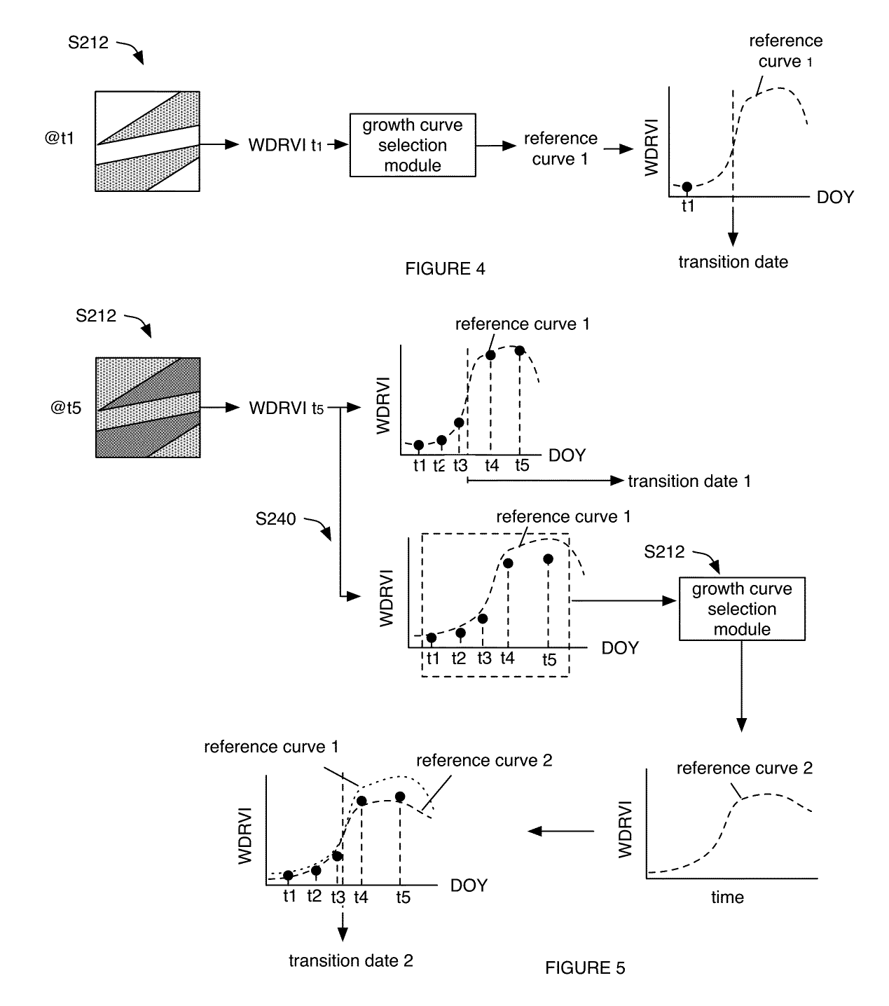

In a first variation, determining the growth curve S210 includes selecting a reference curve based on the measurement value set S212, which functions to classify the measurement value set. The reference curve is preferably selected from a plurality of reference curves, but can alternatively be otherwise determined as the growth curve. As shown in FIG. 3, the reference curve is preferably selected by a growth curve selection module, but can alternatively be selected by any other suitable system. The selected reference curve is preferably one that best fits the measurement value set, but can be any other suitable reference curve. As shown in FIG. 4, the measurement value set used as the basis for growth curve selection can include all past measurement values for the instantaneous growing season, only past measurement values for the instantaneous growing season within a predetermined time window from a reference date, or any other suitable set of past measurement values. The reference curve can additionally be selected based on: parameters of the measurement value set (e.g., values, velocity, acceleration, overall patterns, etc.), yield performance maps (e.g., for the current growing season, aggregate yield performance maps over multiple growing seasons, etc.), reference curves historically selected for the geographic region, reference curves selected (currently or historically) for geographic regions proximal the geographic region, reference curves selected (currently or historically) for geographic regions sharing similar parameters with the geographic region, past environmental parameter values for the geographic region (for the instantaneous growing season, for historic growing seasons, etc.), environmental parameter value forecasts for the geographic region, or any other suitable information.

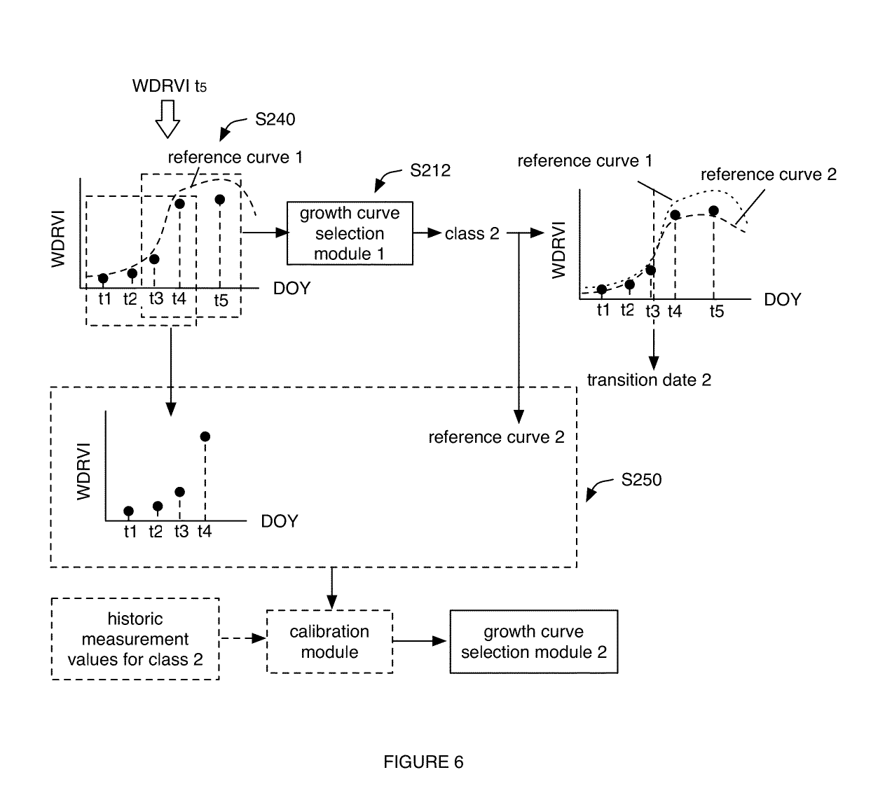

Selecting the reference curve S212 can include: classifying the measurement value set as one of a set of growth classes (e.g., selecting the reference curve using classification) and selecting the reference curve associated with the growth class; selecting the reference curve associated with the growth class that is the mean class prediction based on the measurement value set (e.g., selecting the reference curve using regression); associating the measurement value set with one or more of a set of growth classes and selecting the reference curves associated with the growth classes (e.g., based on feature value similarities, probabilities calculated from feature values, etc.); calculating a probability for each growth class that the respective growth class will be the actual growth curve, selecting the growth class having the highest probability, and selecting the reference curve associated with the growth class; or selecting the reference curve in any other suitable manner. The measurement value set can be classified (e.g., as shown in FIG. 6), categorized, or otherwise labeled based on the measurement values within the set, similarities between the measurement value set and historic or model measurement value sets (e.g., similar parameters, factors, etc.), geographic region parameters (e.g., environmental parameter values), growing season parameters, or based on any other suitable parameter, in combination or alone. Selecting the reference curve can additionally include extracting values of key features (feature values) from the measurement value set or otherwise processing the measurement value set prior to reference curve selection, wherein the extracted values can be used in reference curve selection. In a specific example, the reference curve is selected using a random forest model.

The selected reference curve (or identifier thereof) is preferably stored as the growth curve in association with the geographic region, wherein the stored growth curve is retrieved for the geographic region when a trigger event is detected. The trigger event can be receipt of new measurement value(s) for the geographic region, growth curve re-determination, or any other suitable trigger event.

When a reference curve is selected as the growth curve, the method can additionally include fitting the selected reference curve to the time scale of the measurement value set. Fitting the selected reference curve can include: shifting the reference curve along a time scale until a segment of the reference curve substantially fits the measurement values (e.g., best fits the measurement values, fits the measurement values within a predetermined deviation, optimally fits the measurement values, etc.), scaling the reference curve to fit the measurement values, or otherwise adjusted to fit the measurement values. The adjustment factors are preferably additionally stored in association with the geographic region, but can alternatively be re-determined each time the growth curve is used. However, the reference curve can be used as the growth curve without fitting the curve to the measurement value set.

In this variation, the method can additionally include validating the reference curve previously selected for a geographic region (selected reference curve), based on a new measurement value for the geographic region S240. Validating the selected reference curve (e.g., verifying the selected reference curve) S240 can include: comparing the second measurement value with the measurement value anticipated by the reference curve, validating the selected reference curve when the second measurement value substantially matches the anticipated measurement value, and invalidating the selected reference curve when the second measurement value substantially deviates from the anticipated measurement value. However, the selected reference curve can be otherwise validated or invalidated based on the new measurement value. The growth curve selection module is preferably reinforced when the selected reference curve is validated, but can remain unadjusted or otherwise adjusted in response to selected reference curve validation.

When the selected reference curve is validated, the transition date for the geographic region is preferably maintained (e.g., kept the same) or re-determined from the selected reference curve. When the selected reference curve is invalidated, the method can additionally include selecting a new reference curve based on the updated measurement value set (e.g., including the new measurement value), example shown in FIG. 5. The new reference curve can be selected or classified by the growth curve selection module previously used to select the invalidated reference curve, by a retrained growth curve selection module, by a secondary growth curve selection module, or by any other suitable growth curve selection module.

The reference curve preferably includes a curve shape, but can alternatively or additionally include a curve function, a discrete set of points, or have any other suitable characterization. The reference curve can be a continuous curve, a composite curve, or be otherwise constructed. The reference curve can be predetermined, dynamically determined (e.g., based on the new measurement values), or otherwise determined. The reference curves can be generated by the system (e.g., automatically or pseudo-automatically, using supervised learning methods, using unsupervised learning methods, etc.), be received from a third party, or be otherwise determined. Each crop type, user account, geographic region, growing season, time of year, or any other suitable parameter value can be associated with a different set of reference curves, or be associated with the same set of reference curves. Reference curves are preferably generated based on historic, complete growing season measurement values (e.g., wherein the measurement values span a time period extending from a planting date to a harvesting date), but can alternatively be generated based on partial growing season measurement values, historical curves for the field, standard curves for the crop (e.g., lab or manufacturer provided curves), any other suitable curve associated with the crop, field, or similar fields, or generated based on any other suitable data set. The reference curves can additionally be generated or adjusted based on the historic local conditions for the growing season, based on the treatments applied to the field (e.g., based on user records or entries, estimated based on unexpected changes in the field, etc.), or be based on any other suitable parameter. The reference curves are preferably stored in association with the classes (e.g., factor values, parameter values, etc.) associated with the underlying measurement value set, but can alternatively be associated with one or more classes in any other suitable manner.

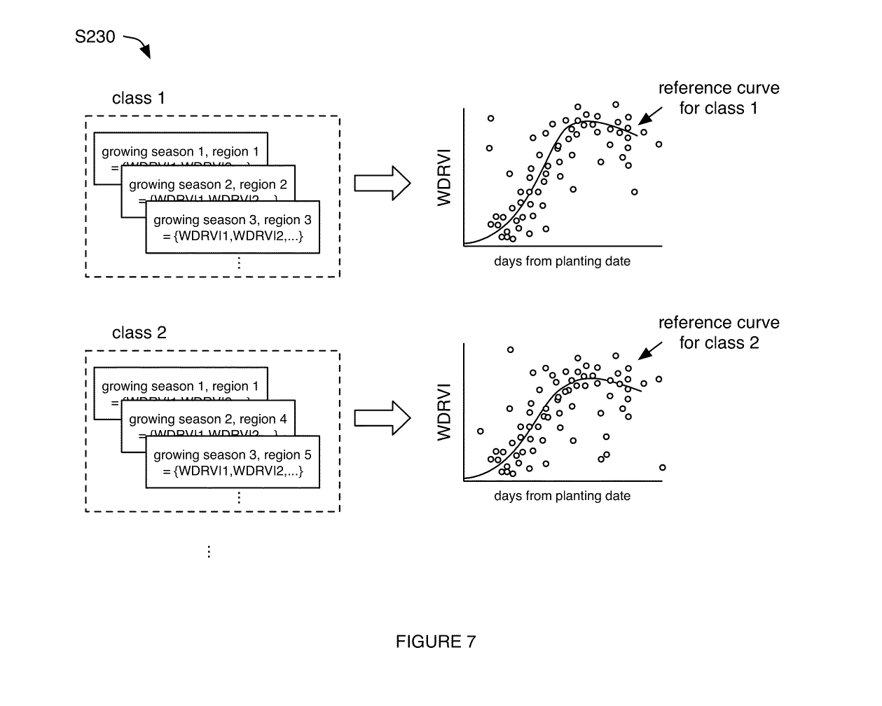

As shown in FIG. 7, generating the reference curve S230 can include: aggregating complete measurement values for historic growing seasons (e.g., growing seasons prior to the instantaneous growing season) of a common class and determining a curve that fits the aggregated data (e.g., using shape fitting models, etc.) as the reference curve for the class. The classes of each measurement value set (e.g., feature values) can be manually assigned to each measurement value set, automatically assigned to each measurement value set, or otherwise assigned to each measurement value set. The measurement value sets within each class preferably share one or more common features (e.g., resultant yield, environmental parameter values or ranges, pest infestation, treatment application, crop type, geographic region, growing season, etc.), but can alternatively be classified in any other suitable manner. However, the reference curves can be otherwise generated.

In one example, a reference curve is generated from sets of measurement values recorded for a single geographic region, wherein the reference curve can be specific to the geographic region. In a second example, a reference curve is generated from sets of measurement values recorded for multiple geographic regions, wherein the crops within the respective geographic regions all exhibited low yield. However, the reference curve can be generated from any suitable set of measurement values. The reference curve can be generated or updated after each growing season is complete (e.g., after harvest), but can alternatively be generated or updated after a new measurement value is determined, after a predetermined number of growing seasons have been completed, or at any other suitable frequency.

As shown in FIG. 6, the method can additionally or alternatively include calibrating the growth curve module S250, which functions to refine the growth curve selection models. The growth curve module can be retrained, recalibrated, remain unadjusted, or be otherwise adjusted in response to selected reference curve invalidation (e.g., determination of a discrepancy between the actual and anticipated measurement values for the geographic region), but can alternatively be updated at a predetermined frequency, in response to receipt of a new measurement value, or be updated at any other suitable frequency. The updated growth curve module can be subsequently used to select growth curves for the geographic region or other geographic regions. The updated growth curve module can be used to select growth curves for the instantaneous growing season (e.g., based on the measurement values to date, in response to receipt of a new measurement value, etc.), select growth curves for past growing seasons, select growth curves for future growing seasons, or be used in any other suitable manner.

In one variation, an example of which is shown in FIG. 6, the growth curve module can be retrained based on a subset of the updated measurement value set and the new reference curve. The subset of the updated measurement value set can include the prior measurement value set (e.g., the measurement value set, excluding the new measurement value), measurement values of the set recorded within a limited temporal window, or any other suitable subset of the updated measurement value set. Alternatively or additionally, the final growth curve determined for the instantaneous growing season and the underlying measurement value set can be used to subsequently refine or otherwise train the growth curve selection module. The growth curve selection module can be retrained at the end of the growing season (e.g., when full growing season data is available), retrained upon prior reference curve invalidation, or retrained at any other suitable time. The growth curve selection module can be retrained for each temporal period associated with each measurement value of the set, retrained for the growing season as a whole, or be retrained to predict the growth curve for any suitable temporal subset of the growing season. However, the growth curve selection module can be updated in any other suitable manner. Retraining the growth curve selection module can include selecting new model parameters (e.g., constants, multiples, etc.), or include updating the growth curve selection model in any other suitable manner.

In one example of the first variation, the method can include: receiving a first measurement value for a geographic region, selecting a reference curve from the set of predetermined reference curves based on the new measurement value, and storing the selected reference curve (or identifier thereof) as the growth curve for the geographic region. In response to subsequent receipt of a second measurement value for the geographic region, the stored reference curve for the geographic region is retrieved and validated using the second measurement value. Upon stored reference curve invalidation, the prior measurement value set and the new reference curve (determined using the updated measurement value set) can be used to retrain the growth curve selection module. The retrained growth curve selection module can be used to determine the growth curve for the updated measurement value set (e.g., determine the most up-to-date growth curve), determine the growth curve when the next measurement value is received, or used to determine the growth curve for any other suitable measurement value set.

### 4.2.A.i.b Fitting the Growth Curve to the Measurement Value Set.

In a second variation, determining a growth curve S210 includes building a segment of a growth curve based on the past measurement values and fitting a growth curve to the segment, an example of which is shown in FIG. 8. Building the segment can include aggregating the past measurement values and plotting the aggregated past measurement values based on the respective recordation times. In one variation, building the segment can include aggregating the measurement values into a measurement value set (e.g., aggregating the vegetation performance values into a vegetation performance value set), ordering the measurement values based on the respective recording times into a time-ordered set (e.g., ordering the vegetative performance values within the vegetative performance value set, based on the respective recording times), and plotting the time-ordered set according to the respective recordation times. However, the segment can be constructed in any other suitable manner.

Fitting a growth curve to the segment can include fitting a shape model to the segment (e.g., using linear or nonlinear regression, using a mean shift algorithm, using active shape models, etc.), adjusting an anticipated growth curve (e.g., predetermined function) to fit the segment, or otherwise fitting a curve to the past measurement values. The shape of the anticipated growth curve can additionally be based on past growth curves for the same field (e.g., the same crop or different crops), past growth curves for other fields (e.g., the same crop or different crops), wherein the other fields can share environmental or historical parameters with the field being analyzed, be based on historical environmental parameters for the field for the growing season to date, or be based on any other suitable set of variables. In this variation, parameters of the growth curve can additionally include adjusting the segment based on local field conditions (e.g., weather, treatments, etc.).

In this variation, the method can additionally include reducing noise in the aggregated measurement values, which functions to generate a cleaner set of data from which the growth curve is generated. Noise reduction (or elimination) is preferably performed after the segment has been built, but can alternatively be performed before the segment is built, after the curve is fitted, or at any other suitable time. Reducing noise in the aggregated measurement values can include: applying Gaussian smoothing to the measurement values (e.g., measurement value set, time-ordered set, etc.), filtering the measurement values (e.g., using linear filters, nonlinear filters, etc.), evolving the measurement values (e.g., by using a partial differential equation), applying non-local averaging to the values, applying wavelet transformation to the values, or otherwise reducing or removing noise from the measurement value set. However, the measurement value set can be processed in any other suitable manner before or after growth curve fitting.

### 4.2.A.i.c Adjusting a Growth Curve Based on the New Measurement Value.

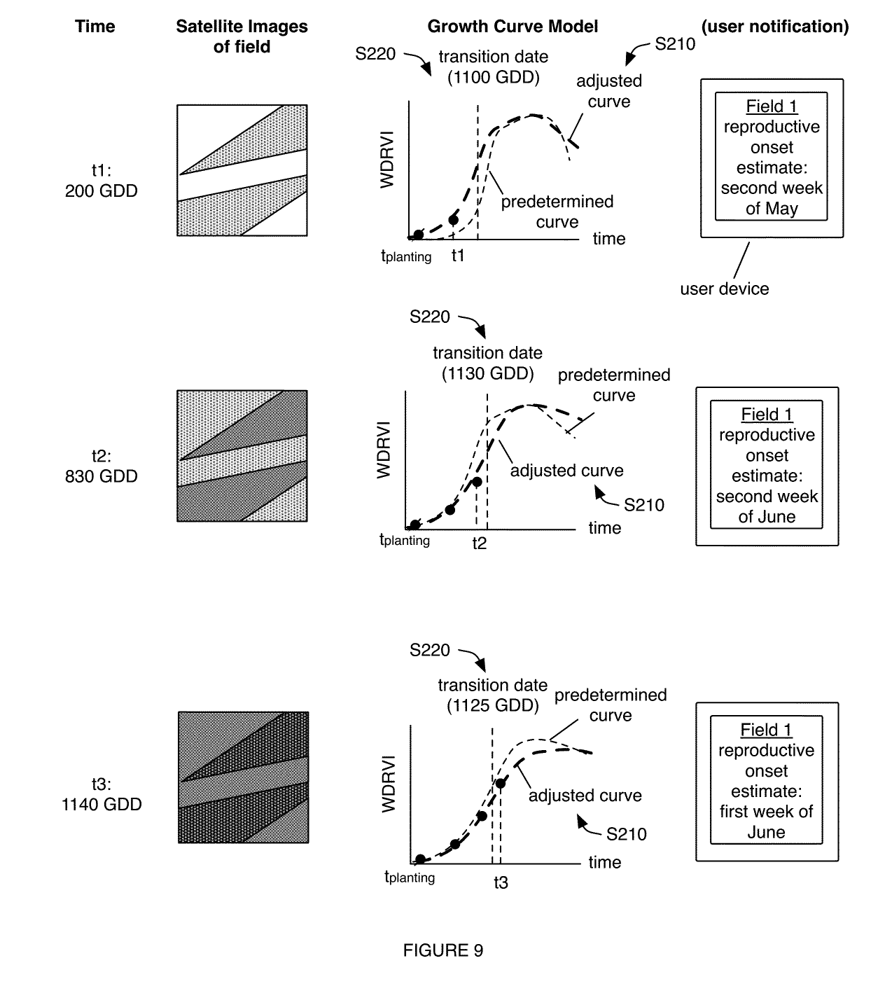

In a third variation, determining a growth curve S210 includes adjusting a predetermined growth curve for the geographic region based on the latest measurement value (e.g., new vegetation index value), an example of which is shown in FIG. 9. The predetermined growth curve can be a reference growth curve, a growth curve fitted to the past measurement values (e.g., wherein the predetermined growth curve is previously determined according to the first variation, using prior measurement values), or be any other suitable growth curve. In this variation, the method can include: retrieving the predetermined growth curve (e.g., from storage, a database, etc.), validating the predetermined growth curve based on the new measurement value, and adjusting the predetermined growth curve when the predetermined growth curve fails validation. Validating the predetermined growth curve based on the new measurement value can include: assessing whether the new measurement value fits the predetermined growth curve; determining an anticipated measurement value for the time associated with the new measurement value and determining whether the new measurement value (e.g., actual measurement value) substantially matches the anticipated measurement value (e.g., within a threshold deviation); or include any other suitable method of validating the growth curve. The predetermined growth curve can fail validation when the new measurement value falls outside of the predetermined growth curve, when a discrepancy between the new measurement value and the predetermined growth curve is determined, or fail validation in any other suitable manner. Adjusting the predetermined growth curve can include: recalculating parameters of the growth curve (e.g., recalculating constants or variables, reapplying the growth curve determination models, etc.), selecting a new reference curve as the growth curve, or otherwise adjusting the predetermined growth curve.

4.2.A.i.d Generating the Growth Curve from a Set of Reference Curves.

In a fourth variation, determining a growth curve S210 includes generating the growth curve based on one or more reference curves. In one example, determining a growth curve includes: identifying reference curves sharing common features with the crop under analysis and aggregating the identified reference curves into the growth curve for the geographic region. Features shared between the identified reference curves and the crop under analysis can include: crop varietal, geographic region, weather patterns, or any other suitable feature. Aggregating the identified reference curves can include: averaging the reference curves (e.g., using a weighted average); extracting common curve features from the identified reference curves and generating a growth curve having the common curve features; or otherwise aggregating the identified reference curves.

However, the growth curve can be determined in any other suitable manner for the geographic region, based on the measurement value set.

### 4.2.A.ii Determining the Transition Date Based on the Growth Curve.

Determining the transition date based on the growth curve S220 functions to identify the date at which the crop field transitions from a vegetative phase to a reproductive phase. The transition date is preferably determined as the date at which the inflection point of the growth curve will occur, but can alternatively be any other suitable date. In a first variation, determining the transition date includes calculating (e.g., deriving) the transition date from the growth curve. This can be particularly desirable when the determined growth curve is characterized as a function, but can be used for any other suitable growth curve characterization. In a second variation, determining the transition date includes applying a Gaussian kernel to determine the inflection point on the growth curve. This can be particularly desirable when the determined growth curve is a reference curve that must be fitted to the timeframe encompassed by the measurement values within the measurement value set (e.g., in the fourth variation of growth curve determination), but can be used for any other suitable growth curve characterization. However, the transition date can be otherwise determined.

In a specific example, as shown in FIG. 9, a resampled curve is generated each time new underlying data (e.g., satellite data) is available using a random forest model and reference curves, based on the new and past field vegetation index values (of a single VI or combination of VIs) for the instantaneous growing season. A Gaussian kernel is preferably used to determine the inflection point on the resampled curve, wherein the date (or set of dates) corresponding to the inflection point can be identified as the transition date. However, the transition date can be otherwise determined.

### 4.2.B Determining the Transition Date Based on the Measurement Value Set

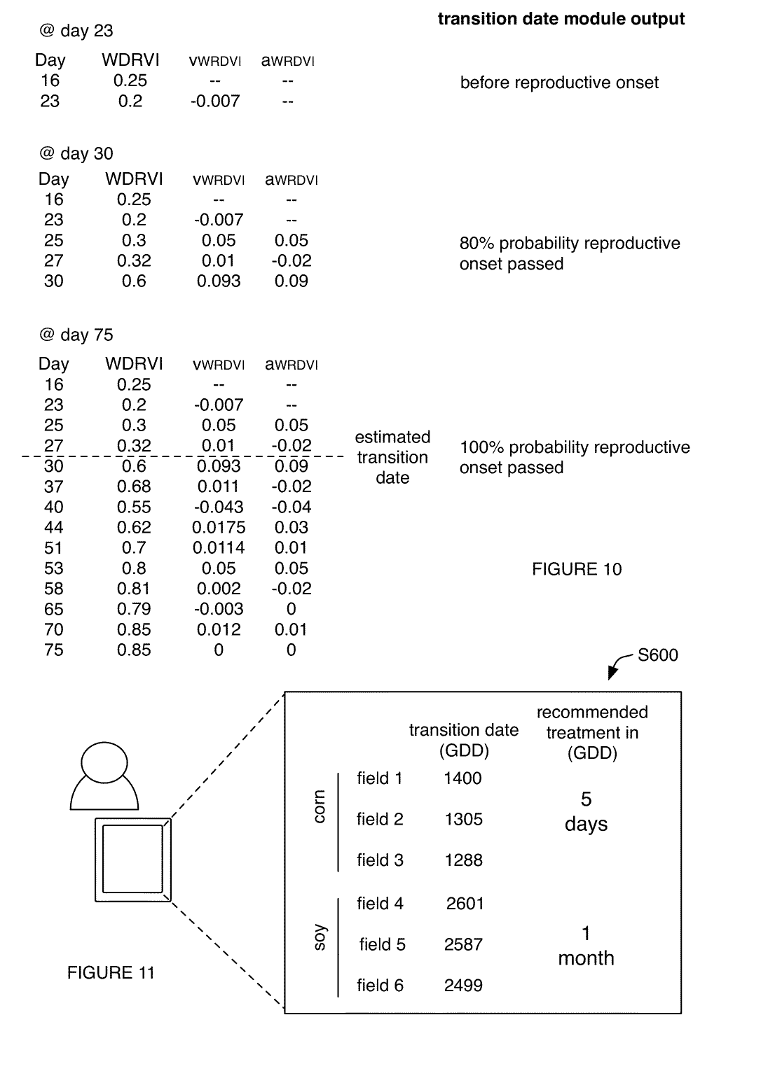

In a second variation, as shown in FIG. 10, determining the transition date S200 includes: determining metrics for the measurement value set, such as measurement value acceleration and/or velocity, and determining the transition date based on the measurement value metrics (e.g., metric values or patterns). For example, the transition date can be estimated to be 10 days out for a soy field when the measurement value has been increasing at a velocity over a threshold velocity for over 15 days. In another example, the transition date can be estimated to be 10 days out for the soy field when the measurement value acceleration increased, then decreased, over the past 15 days. However, the transition date can be computed, selected (e.g., from a chart), or otherwise determined.

### 4.3 Determining the Crop Growth Phase Based on the Transition Date.

Determining the growth phase for the crops based on the transition date S300 functions to determine the general growth phase for the crops. This general growth phase can be used in conjunction with environmental parameter values to determine the growth stage (within the growth phase) for the crop. The general growth phase can additionally or alternatively be used to select which growth phase model should be used to determine the growth stage. In one variation, determining the crop growth phase S300 can include: determining whether the transition date has been surpassed S310 and selectively applying a vegetative model or a reproductive model based on whether the transition date has been passed S320. However, the crop growth phase can be otherwise determined.

4.3.A Determining Whether the Transition Date has been Surpassed.

Determining whether the transition date has been surpassed S310 functions to determine which growing phase the crops are in, such that the appropriate model can be applied to determine the specific growth stage. In a first variation, the crops in the field can be considered to have surpassed the transition date if the instantaneous date (e.g., absolute date, growing degree days since planting, number of days since planting, etc.) is after the estimated transition date. In a second variation, as shown in FIG. 10, the crops in the field can be considered to have surpassed the transition date if vegetation index value derivations or metrics (e.g., velocity, acceleration, etc.) exhibit a predetermined pattern. For example, the field can be considered to have surpassed the transition date if the vegetation index value velocity increased, then decreased. In a second example, the field can be considered to have surpassed the transition date if the vegetation index value acceleration increased, decreased to zero, then increased again. However, transition date surpassing can be determined in response to determination of any other suitable vegetation index value derivation magnitude or pattern. However, the transition date can be determined in any other suitable manner.

Since crops within a field mature at different rates, the field can be considered to have surpassed the transition date if the measurement value for more than a threshold proportion of the field has passed the inflection point for the field. Alternatively, in the variation where individual vegetation index values are calculated for each field sub-region, the field can be considered to have surpassed the transition date if the measurement values for a threshold proportion of the crop field have surpassed the respective inflection points for the sub-regions. Alternatively, in the variation where a measurement value, growth curve, and transition date is determined for the field as a whole, the field can be considered to have surpassed the transition date if the current date is after the transition date. However, the field can be considered to have surpassed the transition date in response to any other suitable condition being met.

### 4.3.B Selectively Applying a Growth Model Based on the Transition Date.

Selectively applying a growth model based on whether the transition date has been passed S320 functions to more reliably determine the specific growth stage that the crop is currently in. The growth model can be a vegetative model, a reproductive model, or any other suitable growth model. Each growth model preferably correlates a growth stage with a temporal measure, but can alternatively correlate a growth stage with temperature or correlate any other suitable set of parameters. In one example, each growth model correlates a growth stage within the respective growth phase with a number of growing degree days. In a specific example, the vegetative model correlates a first number of growing degree days with VE, a second number of growing degree days with V3, a third number of growing degree days with V6, a fourth number of growing degree days with V12, a fifth number of growing degree days with V15, and a sixth number of growing degree days with VT, wherein the crop is considered to be in the respective growth stage if the number of growing degree days is above the prior vegetative stage and below the next vegetative stage. In a second specific example, the reproductive model correlates a first number of growing degree days with R1, a second number of growing degree days with R2, a third number of growing degree days with R4, a fourth number of growing degree days with R5, and a fifth number of growing degree days with R6, wherein the crop is considered to be in the respective growth stage if the number of growing degree days is above the prior reproductive stage and below the next reproductive stage.

A vegetative model is preferably applied when the crop field has not surpassed the transition date, and a reproductive model can be applied when the crop field has surpassed the transition date. However, any other suitable model can be applied. The growth models can be determined based on: historical models for the field; standard models for the crop (e.g., lab- or manufacturer-provided curves); historical measurement values for the crop in the respective growth phase or stage (e.g., across one or more geographic regions and/or growing seasons); historical measurement values for the geographic region in the respective growth phase or stage (e.g., across one or more crop varietals and/or growing seasons); other models associated with the crop, field, or similar fields; or be determined from any other suitable data set. The growth models can be calculated, learned, classified (e.g., automatically, manually, pseudo-manually, etc.), or otherwise generated.

### 4.4 Determining the Crop Growth Stage Based on the Growth Phase and the Environmental Parameters for the Physical Geographic Region.

Determining the crop growth stage based on the growth phase and the environmental parameters for the physical geographic region S400 functions to estimate the instantaneous growth stage for the crop within the geographic region. The environmental parameters for the physical geographic region (e.g., field) are preferably local conditions, but can alternatively be proximal conditions (e.g., conditions of geographic regions within a threshold distance of the field), remote conditions (e.g., conditions of geographic regions outside a threshold distance of the field), or be any other suitable set of conditions. For example, weather data measured for each geographic sub-region of the field (e.g., for 5 m by 5 m field units) by a remote sensing system can be used. In another example, weather data from a weather tower within a threshold distance from the field can be used. However, data associated with any other suitable geographic region can be used.

A time series of environmental parameter values over the growing season to date for the field is preferably used to determine the crop growth stage, but a single environmental parameter value, a subset of all environmental parameter values for the season, or any other suitable set of values can be used to determine the crop growth stage. The environmental parameter can be weather data, treatment data, crop data, field data, or any other suitable data. Weather data can include temperature (thermal units), water supply (e.g., rainfall), light, chill (e.g., chilling days), wind speed and/or duration, or any other suitable weather data. Treatment data can include tillage, the type of machinery used (and any associated use history, such as past crops used with the machinery), planting day, planting worker identifier, or any other suitable treatment data. Field data can include soil composition, soil conductivity, field crop history, biome GGC, or any other suitable field data. However, the crop growth stage can be otherwise determined.

In one example, as shown in FIG. 8, thermal units determined from weather data for the field can be used to determine the number of aggregate growing degree days (GDD) for the field for the growing season to date S410. The crop growth stage can be determined from the applicable model and the number of GDD. In one variation, the GDD from the planting date is used to determine the growth stage. The planting date can be received from a user (e.g., received from a user account, received from a user device), automatically determined (e.g., from a crop plan, from treatment data associated with the field, etc.), be a global planting date, or be otherwise determined. In a second variation, the GDD from the transition date is used to determine the growth stage. However, the GDD can be otherwise determined. In a specific example, when the crop is in the vegetative phase, the GDD from the planting date is used with the vegetative model to determine the vegetative stage of the crop. When the crop is in the reproductive phase, the GDD from the transition date (determined based on the past vegetation index values for the instantaneous growing season) is used with the reproductive model to determine the reproductive stage of the crop. However, the growth stage of the crop can be otherwise determined.

### 4.5 Providing the Estimated Growth Stage to a User.

The method can additionally include providing the estimated growth stage to a user, which functions to inform the user of the estimated growth stage that their crops or fields are in. Providing the estimated growth stage to a user can include: storing the estimated growth stage and/or growth phase in association with the user account; transmitting (e.g., wirelessly or through a wire) and/or displaying the estimated growth stage and/or growth phase to a user device associated with the user account; generating a crop summary report for the user, generating a crop growth history for the user (e.g., wherein the user can scroll through different time points and see the respective growth stage, corresponding images, etc.), or otherwise enabling user access to the estimated growth stage and/or growth phase.

### 4.6 Generating Treatment Recommendations for the Geographic Region.

The method can additionally include generating treatment recommendations for the geographic region based on the estimated growth stage S500. The treatment recommendation can include: treatment date, treatment type, treatment amount, or a recommendation for any other suitable treatment parameter. The treatment recommendation can be generated based on the crop plan for the geographic region (e.g., associated with a user account associated with the geographic region), based on treatments historically performed by the user on the user's crops at the respective growth stage, based on treatments historically performed by a user population on their respective crops at the respective growth stage, based on crop plans from other users that have historically yielded high crop yields, based on treatments recommended by the seed provider for the respective growth stage, based on treatments recommended by research facilities for the respective growth stage, based on crop market data (e.g., anticipated monetary crop value), or based on any other suitable data set. When data from other users, geographic regions, or crops are used to generate the treatment recommendations, the other users, geographic regions, or crops preferably share similar or common parameters with the user associated with the geographic region (first user), but can alternatively be any other suitable user, geographic region, or crop. Similar or common parameters can include: yield goals, geographic proximity, crop varietal, weather patterns, soil characteristics, past treatments for the instantaneous growing season, historic treatments for the geographic region (e.g., across multiple growing seasons), past treatment timing, or any other suitable parameter.

The treatment recommendation is preferably generated for the geographic region as a whole (e.g., based on the estimated growth stage for the geographic region as a whole), such that a single recommendation is generated for the geographic region, but can alternatively or additionally be generated for each geographic sub-region within the geographic region (e.g., based on the estimated growth stage for the respective geographic sub-region) or for any other suitable geographic area. When treatment recommendations are generated for geographic sub-regions within the larger geographic region, the method can additionally include generating a variable-rate treatment plan for the geographic region. The variable-rate treatment plan can specify a treatment parameter for each treatment duration, geographic location (e.g., set of coordinates), or other geographic sub-region identifier. However, the treatment recommendations can be generated for any other suitable set of geographic regions. The treatment recommendations can be provided to a user account (e.g., associated with the geographic region), sent to or displayed on a user device (example shown in FIG. 11), sent to an agricultural machine, or provided to any other suitable endpoint. In one example, the variable-rate treatment plan can be sent to (e.g., wirelessly transmitted, through wired transmission, uploaded, downloaded, etc.) an agricultural machine (e.g., tractor, etc.), wherein the agricultural machine can treat the geographic sub-regions within the geographic region according to the variable-rate treatment plan.

An alternative embodiment preferably implements the above methods in a computer-readable medium storing computer-readable instructions. The instructions are preferably executed by computer-executable components preferably integrated with a growth stage determination system. The growth stage determination system can include a vegetation index determination system configured to determine the vegetation index for a field from field images, a transition date determination system configured to determine the reproductive onset date for a threshold proportion of the field, a growing degree day determination system configured to determine the number of GDD for the field for the growing season to date, a vegetative state system configured to determine the vegetative stage of the crop field from the GDD if the reproductive onset date has not been passed, and a reproductive state system configured to determine the reproductive stage of the crop field from the GDD if the reproductive onset date has been passed. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

We claim:

1. A method for in-season crop growth stage determination for in-situ crops within a geographic region, the method comprising:
a) receiving an image of the geographic region, the image recorded at a first time during a growing season;
b) extracting a vegetative performance value for the geographic region from the image;
c) selecting a reference curve from a plurality of reference curves as a growth curve for the geographic region, based on the vegetative performance value;
d) determining a transition date based on the growth curve;
e) selecting a growth phase model based on a current date and the transition date, comprising:
in response to a current date preceding the transition date, selecting a vegetative model;
in response to the current date exceeding the transition date, selecting a reproductive model;
f) calculating an accumulated growing degree day estimate for the geographic region, based on past environmental parameter values over the growing season for the geographic region; and
g) determining a growth stage for the crops within the geographic region based on the selected growth phase model and the accumulated growing degree day estimate.

2. The method of claim 1, further comprising:
determining a treatment recommendation for the crops within the geographic region based on the crop growth stage; and
sending the treatment recommendation to a device associated with the geographic region.

3. The method of claim 1, further comprising:
extracting a second vegetative performance value for the geographic region from a second image of the geographic region, the second image recorded at a second time during the growing season; and
in response to the second vegetative performance value substantially matching the growth curve for the geographic region, performing d) to g); and
in response to determination of a discrepancy between the second vegetative performance value and the growth curve for the geographic region, performing c) to select a second growth curve for the geographic region based on a second set of vegetative performance values, the second set of vegetative performance values comprising the second vegetative performance value.

4. A method for in-season crop growth stage determination for crops within a geographic region, the method comprising:
receiving an image of the geographic region, the image recorded at a first time during a growing season;
extracting a vegetative performance value for the geographic region from the image;
determining a growth curve based on the vegetative performance value;
determining a transition date based on the growth curve;
selecting a growth phase model based on a current date and the transition date, comprising:
in response to a current date preceding the transition date, selecting a vegetative model;
in response to the current date exceeding the transition date, selecting a reproductive model; and
determining a crop growth stage for the crops within the geographic region based on the selected model and past environmental parameter values for the geographic region for the growing season.

5. The method of claim 4, wherein determining the crop growth stage based on the selected model and past environmental parameter values comprises:
calculating an accumulated growing degree days estimate for the growing season based on the past environmental parameter values for the growing season; and
determining the crop growth stage based on the selected model and the accumulated growing degree days.

6. The method of claim 4, wherein determining a growth curve based on the vegetative performance value comprises selecting a reference curve from a plurality of reference curves as a growth curve for the geographic region based on the vegetative performance value.

7. The method of claim 6, wherein selecting the reference curve from the plurality of reference curves comprises:
determining a growth class for a set of vegetative performance values as one of a plurality of growth classes, wherein each growth class of the plurality is associated with a reference curve, wherein the set of vegetative performance values comprises the vegetative performance value; and
selecting the reference curve associated with the growth class as the growth curve for the geographic region.

8. The method of claim 7, wherein the set of vegetative performance values further comprises past vegetative performance values for the geographic region extracted from past images recorded during the growing season.

9. The method of claim 8, wherein the past images are each recorded within a temporal window of predetermined duration prior to the first time.

10. The method of claim 7, wherein the growth class for the set of vegetative performance values is determined using a random forest model.

11. The method of claim 7, wherein the transition date is determined from the growth curve using a Gaussian kernel.

12. The method of claim 7, further comprising automatically generating reference curves based on vegetative performance values recorded during historic growing seasons.

13. The method of claim 7, further comprising:
extracting a second vegetative performance value for the geographic region from a second image of the geographic region, the second image recorded at a second time during the growing season; and
in response to determination of a discrepancy between the second vegetative performance value and the growth curve for the geographic region, selecting a second growth curve for the geographic region based on a second set of vegetative performance values, the second set of vegetative performance values comprising the second vegetative performance value.

14. The method of claim 13, further comprising: comparing the second vegetative performance value with an expected vegetative performance value calculated from the growth curve, wherein the discrepancy is detected when the second vegetative performance value differs from the expected vegetative performance value beyond a predetermined threshold.

15. The method of claim 13, wherein the first growth curve is selected by a growth curve selection model, the method further comprising training the growth curve selection model based on the second growth curve and the first set of vegetative performance values.

16. The method of claim 4, wherein determining the transition date comprises:
determining an inflection point of the growth curve; and
determining a day of a year corresponding to the inflection point as the transition date.

17. The method of claim 4, wherein the image comprises a set of image elements, wherein extracting a vegetative performance value for the geographic region comprises determining the vegetative performance value based on vegetative performance values of the image elements, wherein extracting the vegetative performance value for the geographic region from the image comprises:
generating a vegetative performance value for each image element of the set; and
calculating the vegetative performance value for the geographic region as a median of the vegetative performance values for the set of image elements.

18. The method of claim 4, wherein the image comprises a remotely-sensed image, wherein the vegetative performance value comprises a wide-dynamic range vegetation index value.

19. The method of claim 4, further comprising wirelessly transmitting data associated with the crop growth stage to a user device associated with the geographic region.

20. The method of claim 19, wherein the data comprises a treatment date recommendation for a crop treatment.
